(19) United States
(12) Patent Application Publication
(10) Pub. No.: US 2023/0144783 A1
(43) Pub. Date: May 11, 2023

(54) PHARMACEUTICAL CONTAINERS INCLUDING SEALING ASSEMBLY WITH FILLER MATERIAL

(71) Applicant: CORNING INCORPORATED, Corning, NY (US)

(72) Inventors: Dane Alphanso Christie, Painted Post, NY (US); Adam Robert Sarafian, Corning, NY (US); Jiangtao Wu, Painted Post, NY (US)

(21) Appl. No.: 17/981,037

(22) Filed: Nov. 4, 2022

Related U.S. Application Data
(60) Provisional application No. 63/277,492, filed on Nov. 9, 2021.

(51) Int. Cl. A61J 1/14; B65D 1/02; B65B 7/28

(52) U.S. Cl. CPC A61J 1/1412; B65D 1/023; B65B 7/2842; A61J 2200/44

(57) ABSTRACT

A sealed pharmaceutical container including: a shoulder; a neck extending from the shoulder; a flange extending from the neck, the flange including: an underside surface extending from the neck; an outer surface extending from the underside surface, the outer surface defining an outer diameter of the flange; and an upper sealing surface extending between the outer surface and an inner surface defining an opening in the sealed pharmaceutical container, and a sealing assembly including: a stopper including a sealing portion extending over the upper sealing surface of the flange and covering the opening, and an insertion portion extending into the opening and in contact with the inner surface of the flange, the stopper having a first CTE; and a filler member encased within the stopper and having a second CTE, the second CTE being lower than the first CTE.

### TECHNICAL FIELD

This application claims the benefit of priority under 35 U.S.C. § 119 of U.S. Provisional Application Ser. No. 63/277,492 filed on Nov. 9, 2021, the content of which is relied upon and incorporated herein by reference in its entirety.

The present specification generally relates to containers for storing pharmaceutical compositions and, more particularly, containers including a sealing assembly formed from a material having a high coefficient of thermal expansion and a filler member having a low coefficient of thermal expansion to improve sealing when subjected to relatively low temperatures.

### BACKGROUND

Pharmaceutical containers, such as vials and syringes, are typically sealed via a stopper or other closure to preserve the integrity of the contained material. Closures are typically made of synthetic rubbers and other elastomers. Such materials beneficially have high permeation resistance and elasticity to facilitate insertion into the container to seal the container's interior. The elasticity of typically-used closure materials, however, may reduce at low temperatures. For example, synthetic rubbers currently in use as material closures may comprise transition temperatures that are greater than or equal to −70° C. and less than or equal to −10° C. Below the transition temperature, closures constructed of such synthetic rubbers may behave as a solid and be unable to expand elastically to compensate for the relatively large difference between coefficients of thermal expansion of the glass and a crimping cap used to secure the closure to the container. Given this, existing sealing assemblies for pharmaceutical containers may fail at temperatures less than or equal to −10° C.

Some biological materials (e.g., blood, serum, proteins, stem cells, and other perishable biological fluids) require storage at temperatures below the glass transition temperatures of conventional elastomers to remain useful. For example, certain RNA-based vaccines may require storage at dry-ice temperatures (e.g., approximately −80° C.) or liquid nitrogen temperatures (e.g., approximately −180° C.) to remain active. Such low temperatures may result in dimensional changes in the closure components (e.g., the glass or plastic container, the stopper, an aluminium cap), leading to issues in the integrity of the seal, and potential contamination of the material stored therein.

### SUMMARY

In one embodiment, a sealed pharmaceutical container includes: a shoulder; a neck extending from the shoulder; a flange extending from the neck, the flange including: an underside surface extending from the neck; an outer surface extending from the underside surface, the outer surface defining an outer diameter of the flange; and an upper sealing surface extending between the outer surface and an inner surface defining an opening in the sealed pharmaceutical container, and a sealing assembly including: a stopper including a sealing portion extending over the upper sealing surface of the flange and covering the opening, and an insertion portion extending into the opening and in contact with the inner surface of the flange, the stopper having a first CTE; and a filler member encased within the stopper and having a second CTE, the second CTE being lower than the first CTE.

In another embodiment, a sealed pharmaceutical container includes: a syringe including: a tubular barrel having an open end and closed end opposite the open end; a needle extending from the closed end and in fluid communication with an interior of the tubular barrel defined by an inner wall of the tubular barrel; and a sealing assembly movably positioned within the interior of the tubular barrel, the sealing assembly including: a stopper having an inner wall and an outer wall opposite the inner wall at least partially in contact with the inner wall of the tubular barrel the stopper having a first CTE; a filler member at least partially encased within the stopper and having a second CTE, the second CTE being lower than the first CTE; and a plunger coupled to the stopper and extending through the open end of the tubular barrel.

In yet another embodiment, a method of sealing a pharmaceutical container includes: providing a pharmaceutical container including a shoulder, a neck extending from the shoulder and a flange extending from the neck, the flange including: an underside surface extending from the neck; an outer surface extending from the underside surface, the outer surface defining an outer diameter of the flange; and an upper sealing surface extending between the outer surface to an inner surface of the pharmaceutical container that defines an opening; inserting a pharmaceutical composition into the pharmaceutical container; and providing a stopper including a sealing portion extending over the upper sealing surface of the flange and covering the opening, and an insertion portion extending into the opening and in contact with the inner surface of the flange, the stopper having a first CTE, a filler member encased within the stopper and having a second CTE, the second CTE being lower than the first CTE.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of an embodiment of a pharmaceutical container, according to one or more embodiments shown and described herein;

FIG. 2 schematically depicts a partial cross-sectional view of another embodiment of a pharmaceutical container, according to one or more embodiments shown and described herein;

FIG. 3 schematically depicts a partial cross-sectional view of another embodiment of a pharmaceutical container, according to one or more embodiments shown and described herein;

FIG. 4 schematically depicts a cross-sectional view of another embodiment of a pharmaceutical container, according to one or more embodiments shown and described herein;

FIG. 5 schematically depicts a cross-sectional view of another embodiment of a pharmaceutical container, according to one or more embodiments shown and described herein;

FIG. 6 schematically depicts a cross-sectional view of another embodiment of a pharmaceutical container, according to one or more embodiments shown and described herein; and

FIG. 7 schematically depicts a cross-sectional view of another embodiment of a pharmaceutical container, according to one or more embodiments shown and described herein.

### DETAILED DESCRIPTION

Reference will now be made in detail to embodiments of sealed pharmaceutical containers including sealing assemblies that maintain container closure integrity at relatively low storage temperatures (e.g., less than or equal to −30° C., less than or equal to −40° C., less than or equal to −50° C., less than or equal to −60° C., less than or equal to −70° C., less than or equal to −80° C., less than or equal to −100° C., less than or equal to −125° C., less than or equal to −150° C., less than or equal to −175° C., less than or equal to −180° C.). In embodiments, the structure of the pharmaceutical containers described herein may vary from that of existing pharmaceutical containers in one or more respects to facilitate the maintenance of a seal at an interface between the pharmaceutical containers and a sealing assembly inserted therein. For example, embodiments of the pharmaceutical containers described herein may be vials (though other container shapes are within the scope of the present disclosure) including a shoulder, a neck, and a flange including an upper sealing surface against which a stopper of a sealing assembly is pressed by a cap. Various characteristics of the upper sealing surface may be adapted to facilitate the maintenance of a seal when the sealed pharmaceutical containers are cooled to such low storage temperatures. For example, in embodiments, the upper sealing surface may include an inclined sealing surface that descends with increasing radial distance from a central axis of the pharmaceutical container. The inclined sealing surface may descend at an angle of greater than 0 degrees (e.g., greater than 0 degrees and less than or equal to 45 degrees) relative to a plane extending over an end of the pharmaceutical container so as to increase an initial force against the stopper applied during a crimping process and increase tolerance for stopper shrinkage when cooled to lower temperatures. In embodiments, the upper sealing surface extends perpendicular to the central axis of the pharmaceutical container (e.g., extends at an angle of greater than or equal 90 degrees and less than or equal to 89.5 degrees) to maximize a contact area between the upper sealing surface and the stopper. In embodiments, various other characteristics of the upper sealing surface (e.g., surface roughness, flatness, and the like) may be tailored to increase the sealing integrity.

In embodiments, the sealing assembly of the pharmaceutical containers described herein may be formed of various combinations of materials to facilitate seal maintenance at low storage temperatures. Sealing assemblies of the present specification may include a stopper, a filler member encased within the stopper, and a metal-containing cap formed from compositions tailored to prevent excessive deformation of the stopper relative to the metal-containing cap at low storage temperatures to maintain sufficient sealing force applied to the stopper via the metal-containing cap. For example, in embodiments, the metal-containing cap may be constructed of a material that increases the CTE thereof over existing, aluminum crimping caps. In embodiments, the metal-containing cap may be constructed of at least one of Zn or Mg instead of Al to provide a higher CTE. In embodiments, the metal-containing cap is constructed of an aluminum-containing polymer composite material. In embodiments, the metal-containing cap is constructed of a metallic alloy comprising at least one of Zn, Al, Mg, Cu. The stopper has a first CTE and the filler member has a second CTE lower than the first CTE. As such, the filler member reduces the amount of shrinkage of the stopper when subjected to relatively low temperatures.

As used herein, the term “container closure integrity” refers to maintenance of a seal at an interface between a pharmaceutical container and a sealing assembly (e.g., between an upper sealing surface of a pharmaceutical container and a stopper) that is free of gaps above a threshold size to maintain a probability of contaminant ingress or reduce the possibility of gas permeability below a predetermined threshold based on the material stored in a pharmaceutical container. For example, in embodiments, a container closure integrity is maintained if a helium leakage rate during a helium leak test described in USP <1207> (2016) is maintained at less than or equal to 1.4×10⁻⁶ cm³/s.

In the embodiments of the pharmaceutical containers described herein, the concentration of constituent components (e.g., SiO₂, Al₂O₃, B₂O₃ and the like) of the glass composition from which the pharmaceutical containers are formed are specified in mole percent (mol. %) on an oxide basis, unless otherwise specified.

The term “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.05 mol. %.

The term “CTE,” as used herein, refers to the coefficient of thermal expansion over a temperature range from about −200° C. to about 300° C., unless stated otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply ab solute orientation.

As used herein, the singular forms “a,” “an” and “the” include plural referents unless the context clearly dictates otherwise. Thus, for example, reference to “a” component includes aspects having two or more such components, unless the context clearly indicates otherwise.

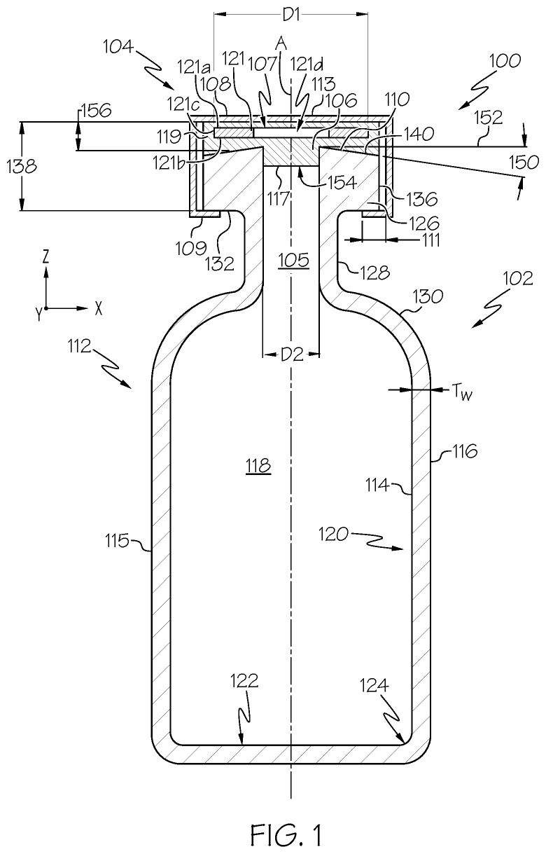

Referring now to FIG. 1, one embodiment of a pharmaceutical container 100 for storing a pharmaceutical formulation is schematically depicted in cross section. The pharmaceutical container 100 includes a glass container 102 and a sealing assembly 104 coupled to the glass container 102 at an opening 105 of the glass container 102. Although referred to herein as a glass container 102, it should be appreciated that, in embodiments, the glass container 102 may be formed from a plastic or any other suitable material. The sealing assembly 104 includes a stopper 106, a filler member 107, and a metal-containing cap 108. In the embodiment depicted in FIG. 1, the stopper 106 comprises an insertion portion 117 and a sealing portion 119. It should be appreciated that, in embodiments, the insertion portion 117 may not be provided. As such, the stopper 106 may not extend into the opening 105 of the glass container 102.

The filler member 107 is encased within the stopper 106, particularly the sealing portion 119 of the stopper 106. The filler member 107 includes a filler body 121 having an upper surface 121a, a lower surface 121b opposite the upper surface 121a, and an outer edge 121c. Although not shown, it should be appreciated that the filler body 121 may have a circular or elliptical geometry, as defined by the outer edge 121c, when viewed from a plan view corresponding to a geometry of an outer edge of the sealing portion 119 of the stopper 106. As such, a distance between the outer edge of the sealing portion 119 and the outer edge 121c of the filler body 121 remains substantially constant along the entire outer edge 121c of the filler body 121. As shown in FIG. 1, the filler member 107 is positioned within the stopper 106 such that the filler body 121 overlaps the insertion portion 117 of the stopper 106, which is shown inserted through the opening 105 formed in the glass container 102. As such, the filler body 121 has a body diameter D1 that is greater than an opening diameter D2 of the opening 105 of the glass container 102. In embodiments, a body channel 121d is formed in the filler body 121 and extends through the upper surface 121a and the lower surface 121b of the filler body 121 to permit a needle, such as that of a syringe, to extend into the glass container 102 through the filler member 107. In embodiments, the body channel 121d has a length greater than the opening diameter D2.

In embodiments, the filler member 107 is formed from a first material such as, for example, glass, a crystalline material, a polymer, a metal, and the like, or any combination thereof. In embodiments, the first material may include, for example, oxide, halide, nitride, chalcogen, or a combination thereof. In embodiments, the first material forming the filler member 107 is coated with a second material. The second material may be, for example, butyl rubber, nitrile rubber, fluoro rubber, butyl silicone rubber, polyacrylate elastomer, and the like, or any combination thereof. Accordingly, the stopper 106 has a first CTE and the filler member has a second CTE less than the first CTE. In embodiments, the second material has a glass transition temperature (T_{g}) between −200° C. to 300° C. In embodiments, the stopper 106 also has a T_{g} between −200° C. to 300° C.

The insertion portion 117 is inserted into the opening 105 of the glass container 102 until the sealing portion 119 contacts an upper sealing surface 110 of the glass container 102. The sealing portion 119 is then pressed against the upper sealing surface 110 via crimping of the metal-containing cap 108 to form a seal at the upper sealing surface 110. Various aspects of the glass container 102 and the sealing assembly 104 are designed to ensure maintenance of container closure integrity of the glass container 102 at low storage temperatures, as described herein.

The glass container 102 generally comprises a body 112. The body 112 has a wall thickness T_{W} which extends between an inner surface 114 and an outer surface 116 of the glass container 102, includes a central axis A, and generally encloses an interior volume 118. In the embodiment of the glass container 102 shown in FIG. 1, the body 112 generally includes a wall portion 120 and a floor portion 122. The wall portion 120 transitions into the floor portion 122 through a heel portion 124. In the depicted embodiment, the wall portion 120 of the glass container 102 defines a flange 126, a neck 128 extending from the flange 126, a barrel 115, and a shoulder 130 extending between the neck 128 and the barrel 115. The floor portion 122 is coupled to the barrel 115 via the heel portion 124. In embodiments, the glass container 102 is symmetrical about the central axis A, with each of the barrel 115, the neck 128, and the flange 126 being substantially cylindrical-shaped.

In embodiments, the glass container 102 may be formed from Type I, Type II, or Type III glass as defined in USP <660>, including borosilicate glass compositions such as Type 1B borosilicate glass compositions under USP <660>. Alternatively, the glass container 102 may be formed from alkali aluminosilicate glass compositions such as those disclosed in U.S. Pat. No. 8,551,898, hereby incorporated by reference in its entirety, or alkaline earth aluminosilicate glasses such as those described in U.S. Pat. No. 9,145,329, hereby incorporated by reference in its entirety. In embodiments, the glass container 102 may be constructed from a soda lime glass composition. In embodiments, the glass container 102 is constructed of a composition having a coefficient of thermal expansion that is greater than or equal to 0×10⁻⁷/K and less than or equal to 100×10⁻⁷/K (e.g., greater than or equal to 30×10⁻⁷/K and less than or equal to 70×10⁻⁷/K).

While the glass container 102 is depicted in FIG. 1 as having a specific form-factor (i.e., a vial), it should be understood that, as discussed in more detail herein, the glass container 102 may have other form factors, including, without limitation, Vacutainers®, cartridges, syringes, ampoules, bottles, flasks, phials, tubes, beakers, or the like. Further, it should be understood that the glass containers described herein may be used for a variety of applications including, without limitation, as pharmaceutical packages, beverage containers, or the like.

Although referred to herein as a glass container 102, it should be appreciated that the glass container 102 may be formed of a material other than glass such as, for example, a polymer, metal, ceramic, and the like. Further, the coefficient of thermal expansion of these materials can be greater than or equal to 0×10⁻⁷/K and less than or equal to 8,000×10⁻⁷/K.

The wall thickness T_{W} of the glass container 102 may vary depending on the implementation. In embodiments, the wall thickness T_{W} of the glass container 102 may be from less than or equal to 6 millimeters (mm), such as less than or equal to 4 mm, less than or equal to 2 mm, less than or equal to 1.5 mm, or less than or equal to 1 mm. In some embodiments, the wall thickness T_{w} may be greater than or equal to 0.1 mm and less than or equal to 6 mm, greater than or equal to 0.3 mm and less than or equal to 4 mm, greater than or equal to 0.5 mm and less than or equal to 4 mm, greater than or equal to 0.5 mm and less than or equal to 2 mm, or greater than or equal to 0.5 mm and less than or equal to 1.5 mm. In embodiments, the wall thickness T_{W} may be greater than or equal to 0.9 mm and less than or equal to 1.8 mm. The wall thickness T_{W} may vary depending on the axial location within the glass container 102.

As depicted in FIG. 1, the flange 126 comprises an underside surface 132, an outer surface 136, and the upper sealing surface 110. The outer surface 136 may define an outer diameter of the flange 126. In embodiments, the metal-containing cap 108 of the sealing assembly 104 is crimped around the flange 126 via any suitable crimping method (e.g., a pneumatic crimping apparatus or the like). During the sealing process, the stopper 106 is inserted into the opening 105, and a compression force is applied to the metal-containing cap 108 during crimping. For example, as depicted in FIG. 1, the metal-containing cap 108 includes an underlying portion 109 that contacts the underside surface 132 of the flange 126 to force the stopper 106 to remain in a compressed state and form a seal after the crimping process. Compression of the stopper 106 generates a residual sealing force within the flange 126 that maintains compression on the stopper 106 after the metal-containing cap 108 is crimped into place. In embodiments, the length of the underlying portion 109 of the metal-containing cap 108 that directly contacts the underside surface 132 of the flange 126 possesses a length 111 (e.g., in the X-direction depicted in FIG. 1) that is greater than or equal to 1 mm to facilitate maintenance of residual sealing force within the stopper 106 at storage temperatures of less than or equal to −80° C.

When the glass container 102 is cooled to or relatively low storage temperatures of less than or equal to −80° C. (e.g., less than or equal to −80° C., less than or equal to −100° C., less than or equal to −125° C., less than or equal to −150° C., less than or equal to −175° C., −180° C.), each of the constituent components of the glass container 102 may undergo a volumetric shrinkage that is dependent on the thermal properties of that component. As depicted in FIG. 1, the volume of material disposed between the underlying portion 109 and an upper portion 113 of the metal-containing cap 108 circumscribes the sealing portion 119 of the stopper 106 and the flange 126 of the glass container 102. If the combination of the stopper 106 and the flange 126 shrinks in an amount that is greater than the amount of shrinkage of the metal-containing cap 108, the compression on the stopper 106 provided by the metal-containing cap 108 may diminish, increasing the probability of the seal at the upper sealing surface 110 being broken. However, the filler member 107 having a CTE lower than the CTE of the stopper reduces the amount of shrinkage that the stopper 106 would otherwise exhibit. As such, the sealing assembly 104 including the filler member 107 encased within the stopper 106 reduces the overall CTE of the sealing assembly 104, thereby reducing the likelihood of the seal at the upper sealing surface 110 being broken.

For example, as depicted in FIG. 1, the combined height 138 (e.g., in the Z-direction depicted in FIG. 1) of the flange 126 and the stopper 106 is approximately equal to the distance between the upper portion 113 and the underlying portion 109 of the metal-containing cap 108. In such a state, the metal-containing cap 108 may compress the stopper 106 against the upper sealing surface 110 to form a seal. If the combined height 138 shrinks to a greater extent than the metal-containing cap 108, however, the compression of the stopper 106 may diminish, reducing the residual seal force. To maintain a compression of the stopper 106, shrinkage ΔL of the metal-containing cap 108, the stopper 106, and the glass container 102 may satisfy the following relation:

ΔL_{cap}=ΔLᵥᵢₐₗ+ΔLₛₜₒₚₚₑᵣ (1)

where the shrinkage of ΔL of each component may be approximated by

ΔL=Lᵢ×(e^{∫α(T)}−1), (2)

where Lᵢ is an initial dimension of the component and α(T) is the temperature-dependent CTE of the material out of which each of the metal-containing cap 108, the stopper 106, and the glass container 102 are constructed.

In embodiments, the stopper 106 is constructed of a polymer-based material (e.g., butyl or other synthetic rubbers). Such materials may comprise a T_{g} that is greater than or equal to −70° C. and less than or equal to −10° C. Below the T_{g}, the stopper 106 may behave as a solid (e.g., lose its elasticity), resulting in a diminished sealing force at the upper sealing surface 110. For example, if the stopper 106 is cooled to beneath its T_{g}, the stopper 106 may not fill the entirety of the gap between the upper sealing surface 110 and the upper portion 113 of the metal-containing cap 108, increasing the probability of the seal breaking. That is, the stopper 106 effectively behaves as two different materials as it is cooled below its glass transition temperature: an elastic material above the transition temperature, and a solid glass below the transition temperature. According to equation 2 herein, the shrinkage of the stopper 106 disposed between the flange 126 and the upper portion 113 of the metal-containing cap 108 when cooled from an initial temperature Tᵢ to a final temperature T_{F} may be approximated as:

$$Δ {L}_{stopper} = {L}_{i , stopper} x ( {e}^{{\int }_{{T}_{i}}^{{T}_{g}} {α}_{rubber} ( T ) dT + {\int }_{{T}_{g}}^{{T}_{F}} {α}_{glass} ( T ) dT} - 1 ) , \qquad ( 3 )$$

where α_{glass} refers to the CTE of the glass-like material that the rubber of the stopper 106 transforms into below its glass transition temperature T_{g}. In embodiments, to maintain the seal, the metal-containing cap 108 and stopper 106 may be constructed such that the shrinkage of the metal-containing cap 108 is greater than or equal to the combined shrinkage of the glass container 102 and the stopper 106. To facilitate meeting such a relationship, the shrinkage of the metal-containing cap 108 may be increased, the shrinkage of the stopper 106 and flange 126 may be decreased, or any combination thereof. Alternatively or additionally, the structure of the glass container 102 may be designed to increase an initial capping compression imparted on the stopper 106, thereby providing a greater tolerance for shrinkage of the stopper 106.

Additionally, to maintain a compression of the stopper 106, the CTE and a thickness of the filler member 107 extending between the upper surface 121a and the lower surface 121b of the filler body 121 should satisfy the following condition:

$${h}_{rubber} \leq \frac{{α}_{cap} - {α}_{cartridqe}}{{α}_{r u b b e r} - {α}_{filler}} * {h}_{flange} + \frac{{α}_{cap} - {α}_{filler}}{( {α}_{r u b b e r} - {α}_{filler} )} * {h}_{stopper} \qquad ( 4 )$$

where h_{rubber} refers to the thickness of the rubber coating in the stopper 106, α_{cap} refers to the CTE of the metal-containing cap 108, α_{cartridge} refers to the CTE of the glass container 102, αₛₜₒₚₚₑᵣ refers to the CTE of the stopper 106, α_{filler} refers to the CTE of the filler member 107, and h_{flange} refers to a thickness or distance 156 of the flange 126, and h_{rubber} refers to the thickness of the stopper 106, which includes the rubber coating and the filler member 107 in a vertical direction.

In embodiments, the metal-containing cap 108 is constructed of aluminium, which may have a CTE of approximately 240×10′/K. Typical rubbers out of which the stopper 106 is constructed (e.g., Butyl 325, Butyl 035, etc.) may have CTEs of greater than or equal to 1,400×10⁷/K. That is, purely in terms of CTE differential, the metal-containing cap 108 has a tendency to shrink less than the stopper 106, resulting in a diminished sealing force at lower storage temperature. In addition to the above-described CTE mismatch, as depicted in FIG. 1, the stopper 106 may make up a larger volumetric percentage of the sealing assembly 104 than the metal-containing cap 108, further compounding the tendency of the stopper 106 to undergo a larger thermal shrinkage.

In the embodiment depicted in FIG. 1, to counteract such tendencies of the stopper shrinkage to overwhelm the shrinkage of the metal-containing cap 108 at low storage temperatures, the structure of the glass container 102 has been modified to deviate from existing glass containers to provide greater compression of the stopper 106 during the process of crimping the metal-containing cap 108. Specifically, in embodiments, the upper sealing surface 110 includes an inclined sealing surface 140, such as that disclosed in U.S. Patent Application Publication No. 2021/0212893, hereby incorporated by reference in its entirety. The inclined sealing surface 140 extends between the outer surface 136 of the flange 126 and the inner surface 114 of the glass container 102. The inclined sealing surface 140 extends at an angle 150 to a plane 152 extending through an end 154 of the opening 105. The plane 152 may be a planar surface that rests on top of the glass container 102 at the opening 105 (e.g., that rests on peaks of the inclined sealing surface 140). In embodiments, the plane 152 connects points extending around the upper sealing surface 110 that are most distant from a reference point (e.g., the floor portion 122, see FIG. 1) of the glass container 102. The plane 152 may extend through the top of the glass container 102 in a direction perpendicular to the central axis A of the glass container 102 (e.g., in the X-direction depicted in FIG. 1). In embodiments, the plane 152 extends perpendicular to the portion of the inner surface 114 defining the opening 105.

The angle 150, as described herein, may be referred to as a “flange angle.” Flange angles relative to the plane 152 may be measured in a variety of different ways. For example, in embodiments, to determine an extension direction for the inclined sealing surface 140, an image may be captured of the glass container 102, and image processing techniques may be used to determine the angle 150 of the inclined sealing surface 140 (relative to the plane 152). In embodiments, the extension direction of the inclined sealing surface 140 is measured via finding a plane that extends between a peak of the inclined sealing surface 140 (e.g., having the greatest distance in the Z-direction from the underside surface 132) and a second highest point on the inclined sealing surface 140 (e.g., the extension direction of the inclined sealing surface 140 is measured via a plane that rests on the peak of the inclined sealing surface 140 and another point of the inclined sealing surface 140 that is lower than the peak relative to the plane 152). In embodiments, the extension direction of the inclined sealing surface 140 is measured via connecting points on the inclined sealing surface 140 that are a predetermined distance (e.g., 0.1 mm, 0.2 mm, 0.5 mm, 1.0 mm, etc.) outward from the inner surface 114 and inward of the outer surface 136 (e.g., the points may be taken at a uniform distribution of spatial points extending between the inner surface 114 and the outer surface 136). In embodiments, the extension direction of the inclined sealing surface 140 is measured by curve fitting a linear plane to a plurality of different points distributed throughout the entirety of the inclined sealing surface 140.

In embodiments, the angle 150 is greater than 5 degrees and less than or equal to 45 degrees (e.g., greater than 5 degrees and less than or equal to 40 degrees, greater than 5 degrees and less than or equal to 40 degrees, greater than 5 degrees and less than or equal to 30 degrees, greater than 5 degrees and less than or equal to 20 degrees, greater than 5 degrees and less than or equal to 10 degrees). In embodiments, the angle 150 is substantially uniform around a circumference of the glass container 102 (e.g., when measured at a plurality of azimuthal orientations, each of the measurements may be within 0.5 degrees of one another). In existing glass containers, the angle 150 is typically around 3 degrees. As such, in the glass container 102, the inclination of the upper sealing surface 110 relative to the plane 152 is increased by at least 50% over existing glass containers. The greater inclination of the upper sealing surface 110 tends to increase stopper compression at low storage temperatures. The angle 150 may create a compression gradient within the stopper 106 as a result of crimping the metal-containing cap 108. For example, in embodiments, a compression of the stopper 106 may increase with increasing radial distance from the outer surface 136 such that the compression of the stopper 106 is greater closer to the inner surface 114. Such greater compression with proximity to the inner surface 114 may prevent gaps from forming in the seal as the stopper 106 shrinks with cooling.

Referring still to FIG. 1, as a result of the angle 150, a distance 156 between the upper portion 113 of the metal-containing cap 108 and the upper sealing surface 110 may vary as a function of radial distance from the central axis A to a greater extent than existing glass containers. Given this, the stopper 106 is compressed to a greater extent proximate to the opening 105 than at peripheral regions of the stopper 106 disposed near the outer surface 136 of the flange 126. Such greater compression results in a greater compression of the stopper 106 using the same crimping process, providing a higher tolerance for shrinkage of the stopper 106. Additionally, the inclined sealing surface 140 reduces the term L_{i,stopper} in equation 3 above proximate to the opening 105. This reduces the amount of shrinkage.

Although not illustrated herein, it should be understood that alternatives to the glass container 102 described herein with respect to FIG. 1 may be used while still maintaining container closure integrity at storage temperatures less than or equal to −80° C. For example, the upper sealing surface 110 may extend in the plane 152 extending through the end 154 of the opening 105 in the glass container 102. In embodiments, the upper sealing surface 110 extends substantially perpendicular (e.g., at an angle greater than or equal to 89.5 degrees and less than or equal to 90.5 degrees) to the central axis A of the glass container 102. In embodiments, the upper sealing surface 110 extends substantially perpendicular to the inner surface 114 of the glass container 102 defining the opening 105. Such an upper sealing surface 110 beneficially increases a contact area between the stopper 106 and the upper sealing surface 110 and may increase the probability of maintaining integrity of the seal.

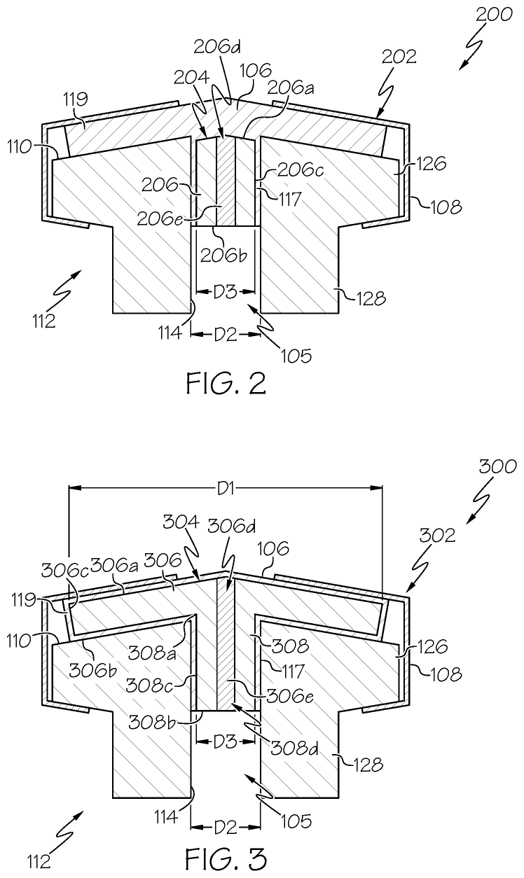

Referring now to FIG. 2, a further embodiment of a pharmaceutical container 200 is illustrated including the glass container 102 and a sealing assembly 202. The sealing assembly 202 includes the stopper 106 and a filler member 204. Rather than the filler member 204 including the filler body 121 extending across the opening 105 formed in the glass container 102, the filler member 204 extends at least partially within and through the opening 105. However, it should be appreciated that the above features of the filler member 107, such as the material of formation and CTE, are equally applicable to the filler member 204 discussed herein.

The filler member 204 is at least partially encased within the stopper 106, particularly the insertion portion 117 of the stopper 106 rather than within the sealing portion 119 of the stopper 106. With more particularity, the filler member 204 includes a filler protrusion 206 having an upper surface 206a, a lower surface 206b opposite the upper surface 206a, and an outer edge 206c. In embodiments, the filler member 204 may not be encased within the stopper 106 at the lower surface 206b thereof. In other embodiments, the filler member 204 may be fully encased within the stopper 106. In embodiments, the upper surface 206a of the filler protrusion 206 may be tapered radially outwardly conforming to a taper formed in the upper surface 121a of the sealing portion 119 of the stopper 106, as shown in FIG. 2. Although not shown, it should be appreciated that the filler protrusion 206 may have a circular or elliptical geometry, as defined by the outer edge 206c, when viewed from a plan view corresponding to a geometry of an outer edge of the insertion portion 117 of the stopper 106. As such, a distance between the outer edge of the insertion portion 117 and the outer edge 206c of the filler protrusion 206 remains substantially constant along the entire outer edge 206c of the filler protrusion 206. As shown in FIG. 2, the filler member 204 is positioned within the stopper 106 such that the filler protrusion 206 extends through the insertion portion 117 of the stopper 106, which is shown inserted through the opening 105 formed in the glass container 102, and parallel to the inner surface 114 of the glass container 102. As such, the filler protrusion 206 has a protrusion diameter D3 that is less than the opening diameter D2 of the opening 105 of the glass container 102. In embodiments, a protrusion channel 206d is formed in the filler protrusion 206 and extends through the upper surface 206a and the lower surface 206b of the filler protrusion 206 to permit a needle, such as that of a syringe, to extend into the glass container 102 through the filler member 204. In embodiments, the protrusion channel 206d may be filled with a sealing material 206e.

Referring now to FIG. 3, a further embodiment of a pharmaceutical container 300 is illustrated including the glass container 102 and a sealing assembly 302. The sealing assembly 302 includes the stopper 106 and a filler member 304. The filler member 304 includes a filler body 306, similar to the filler body 121, and a filler protrusion 308, similar to the filler protrusion 206, discussed herein. The filler body 306 and the filler protrusion 308 may be formed as a one-piece, monolithic structure. As such, the filler member 304 extends both across the opening 105 and within the opening 105 formed in the glass container 102 rather than only one or the other, as described in the above embodiments. It should be appreciated that the above features of the filler members 107, 204, such as the material of formation and CTE, are equally applicable to the filler member 304 discussed herein.

The filler member 304 is at least partially encased within the stopper 106. Particularly the filler body 306 is encased within the sealing portion 119 of the stopper 106 and the filler protrusion 308 is at least partially encased within the insertion portion 117 of the stopper 106. With more particularity, the filler body 306 has an upper surface 306a, a lower surface 306b opposite the upper surface 306a, and an outer edge 306c, and the filler protrusion 308 also has an upper surface 308a, a lower surface 308b opposite the upper surface 308a, and an outer edge 308c. In embodiments, the upper surface 306a of the filler body 306 may be tapered radially outwardly conforming to a taper formed in the upper surface 121a of the sealing portion 119 of the stopper 106, as shown in FIG. 3. Although not shown, it should be appreciated that the filler body 306 and the filler protrusion 308 may have a circular or elliptical geometry, as defined by the outer edge 306c and the outer edge 308c, respectively, when viewed from a plan view corresponding to a geometry of the outer edge of the sealing portion 119 and the outer edge of the insertion portion 117 of the stopper 106, respectively. As such, a distance between the outer edge of the sealing portion 119 and the outer edge 306c of the filler body 306 remains substantially constant along the entire outer edge 306c of the filler body 306. Similarly, a distance between the outer edge of the insertion portion 117 and the outer edge 308c of the filler protrusion 308 remains substantially constant along the entire outer edge 308c of the filler protrusion 308. In embodiments, a body channel 306d, such as the body channel 121d, is formed in the filler body 306 and a protrusion channel 308d, such as the protrusion channel 206d, is formed in the filler protrusion 308. The body channel 306d and the protrusion channel 308d may be coaxial with one another to extend entirely though the filler member 304 and permit a needle, such as that of a syringe, to extend into the glass container 102 through the filler member 304. In embodiments, the body channel 306d and the protrusion channel 308d may be filled with a sealing material 306e.

As shown in FIGS. 1-3, it should be appreciated that a gap may be formed between outer surfaces of the sealing portion and the metal-containing cap, as well as between an outer surface of the flange and the metal-containing cap. Alternatively, as discussed herein, the outer surfaces of the sealing portion and the metal-containing cap, as well as the outer surface of the flange and the metal-containing cap, may be in contact with one another such that no gap is provided. Additionally, in embodiments, it should be noted that no sharp corners will be provided on the sealing assemblies discussed herein and, rather, any angular surfaces should be chamfered or rounded to avoid the stress concentration.

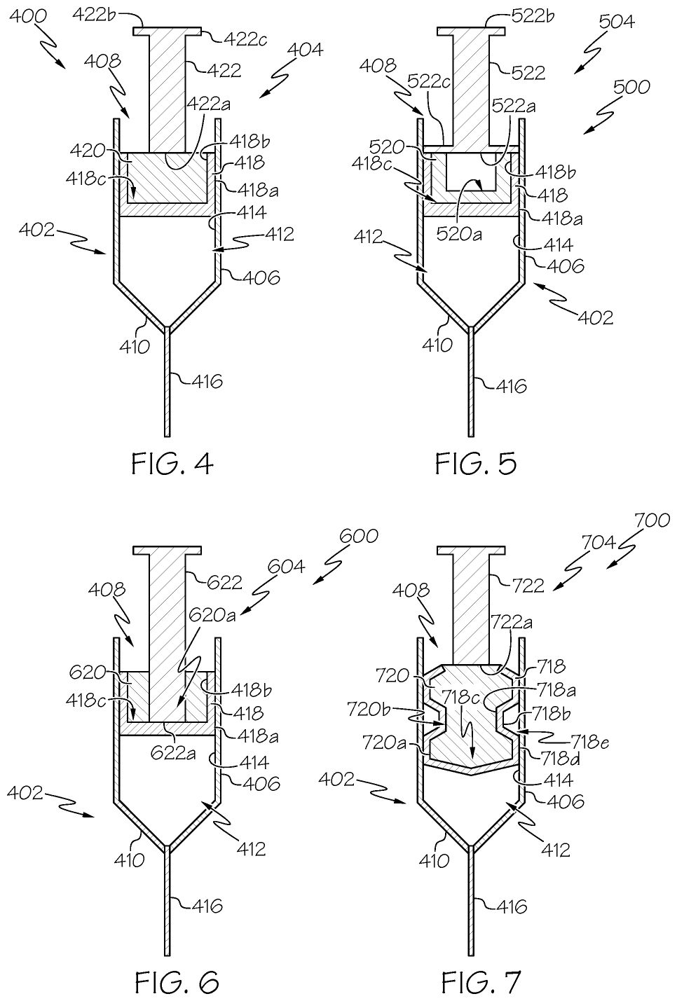

Referring now to FIGS. 4-7, embodiments of a pharmaceutical container are illustrated including a container depicted as a syringe, and a filler member provided within a stopper of the pharmaceutical container for sealing the syringe. With respect to FIG. 4, a pharmaceutical container 400 is illustrated including a container, depicted herein as a syringe 402, and a sealing assembly 404. It should be appreciated that the above features of the glass container 102, such as the material of formation and CTE, are equally applicable to the syringe 402 discussed herein. However, in embodiments, the syringe 402 may be formed from a material other than glass such as, for example, plastic. The syringe 402 includes a tubular barrel 406 having an open end 408 and a closed end 410 opposite the open end 408. In embodiments, the closed end 410 of the syringe 402 is tapered. The tubular barrel 406 has an interior 412 defined by an interior wall 414 of the tubular barrel 406. A needle 416 is provided at the closed end 410 of the syringe 402 and in fluid communication with the interior 412 of the tubular barrel 406 to direct fluid from within the interior 412 out of the syringe 402.

The sealing assembly 404 is movably positioned within the interior 412 of the tubular barrel 406 and includes a stopper 418, a filler member 420, and a plunger 422. The stopper 418 has an outer wall 418a and an inner wall 418b opposite the outer wall 418a. When the stopper 418 is positioned within the tubular barrel 406, the outer wall 418a contacts the interior wall 414 of the tubular barrel 406. The inner wall 418b of the stopper 418 defines a recess 418c which receives the filler member 420. As such, the filler member 420 is at least partially encased within the stopper 418.

The plunger 422 has a first end 422a and a second end 422b opposite the first end 422a. The first end 422a of the plunger 422 may be fixed, such as by being adhered, sonic welded, or the like, to one or both of the stopper 418 and the filler member 420. As shown, the first end 422a of the plunger 422 is secured to and extends from the filler member 420. The plunger 422 may include a lip 422c formed at the second end 422b thereof opposite the stopper 418 and the filler member 420. The lip 422c assists with manually positioning the plunger 422, and more particularly the sealing assembly 404, within the interior 412 of the syringe 402.

It should be appreciated that the above features of the stopper 106 and the filler member 107, such as the material of formation and CTE, are equally applicable to the stopper 418 and the filler member 420, respectively, discussed herein. As such, the stopper 418 has a first CTE and the filler member 420 has a second CTE lower than the first CTE. Additionally, in embodiments, the tubular barrel 406 has a third CTE greater than the second CTE of the filler member 420. Accordingly, the filler member 420 is formed from a first material such as, for example, glass, a crystalline material, a polymer, a metal, and the like, or any combination thereof. In embodiments, the first material forming the filler member 420 is coated with a second material. The second material may be, for example, butyl rubber, nitrile rubber, fluoro rubber, butyl silicone rubber, polyacrylate elastomer, and the like, or any combination thereof.

When the CTE of the stopper 418 is approximately the same or lower than the CTE of the tubular barrel 406, the likelihood of a gap being formed between that no is significantly reduced. The CTE and thickness of the filler member 420 should satisfy the following equation:

$${α}_{filler} \leq {α}_{c a r t ridge} - \frac{Δ r}{{r}_{filler}} * ( {α}_{stopper} - {α}_{cartridge} ) \qquad ( 5 )$$

where α_{filler}, α_{cartridge}, and α_{plunger} are the CTE of the filler member 420, the tubular barrel 406, and the stopper 418, respectively, Δr is the thickness of the stopper 418, and r_{filler} is the size or radius of the filler member 420.

It should be appreciated that, the tubular barrel 406 may be formed of a material other than glass such as, for example, plastic. However, if the tubular barrel 406 is formed of glass, the CTE difference between the stopper 418 and the tubular barrel 406 may be relatively large. Since the CTE of glass is already low, then it is better to reduce the thickness of the stopper 418 so that the CTE requirement of filler member 420 can be more easily satisfied. In this case, the CTE of the filler member 420 should satisfy the following equation:

$$\frac{{α}_{filler}}{{α}_{cartridge}} \leq 1 - \frac{Δ r}{{r}_{filler}} * ( \frac{{α}_{rubber}}{{α}_{cartridge}} - 1 ) \qquad ( 6 )$$

Referring now to FIG. 5, a pharmaceutical container 500 is illustrated including the syringe 402 and a sealing assembly 504. The pharmaceutical container 500 is substantially similar to the pharmaceutical container 400 depicted in FIG. 4 and thus, like reference numerals are used to indicate like parts. The sealing assembly 504 includes the stopper 418, a filler member 520, and a plunger 522. The filler member 520 is identical to the filler member 420, with the exception of a cavity 520a being formed therein. As such, the overall mass of the filler member 520 is reduced while still providing the benefit of reducing shrinkage and deformation of the stopper 418 when the pharmaceutical container 500 is subjected to relatively low temperatures. As a result, a seal formed by contact between the outer wall 418a of the stopper 418 and the interior wall 414 of the tubular barrel 406 is maintained.

Additionally, the plunger 522 has a first end 522a and a second end 522b opposite the first end 522a. A flange 522c is formed at the first end 522a of the plunger 522 and extends across the cavity 520a formed in the filler member 520. As such, the flange 522c causes the cavity 520a to be closed off from the rest the interior 412 defined by the tubular barrel 406. The flange 522c extends across at least the filler member 520 and, in embodiments, extends across the stopper 418 as well. In embodiments, the flange 522c has a width extending across the interior 412 of the tubular barrel 406, and thus across both the filler member 520 and the stopper 418, such that opposite ends of the flange 522c contact the interior wall 414 of the tubular barrel 406. This ensures a fluid tight seal between the plunger 522, the stopper 418, and the tubular barrel 406. The first end 522a of the plunger 522 may be fixed, such as by being adhered, sonic welded, or the like, to one or both of the stopper 418 and the filler member 520. It should be appreciated that the above features of the filler member 107, such as the material of formation and CTE, are equally applicable to the filler member 520 discussed herein. As such, the filler member 520 has a second CTE lower than the first CTE of the stopper 418. Additionally, in embodiments, the second CTE of the filler member 520 is lower than a third CTE of the tubular barrel 406.

Referring now to FIG. 6, a pharmaceutical container 600 is illustrated including the syringe 402 and a sealing assembly 604. The pharmaceutical container 600 is substantially similar to the pharmaceutical containers 400, 500 depicted in FIGS. 4 and 5, respectively, and thus, like reference numerals are used to indicate like parts. The sealing assembly 604 includes the stopper 418, a filler member 620, and a plunger 622. The filler member 620 is identical to the filler member 620, with the exception of a channel 620a open at opposite ends thereof being formed therein rather than the cavity 520a closed at one end. As such, the filler member 620 is ring-shaped. Thus, the overall mass of the filler member 620 is further reduced while still providing the benefit of reducing shrinkage and deformation of the stopper 418 when the pharmaceutical container 600 is subjected to relatively low temperatures. Additionally, the channel 620a formed in the filler member 620 permits the plunger 622 to extend entirely through the filler member 620 and contact the stopper 418 at a first end 622a thereof. The first end 622a of the plunger 622 may be fixed, such as by being adhered, sonic welded, or the like, to the stopper 418. It should be appreciated that the above features of the filler member 107, such as the material of formation and CTE, are equally applicable to the filler member 620 discussed herein. As such, the filler member 620 has a second CTE lower than the first CTE of the stopper 418. Additionally, in embodiments, the second CTE of the filler member 620 is lower than a third CTE of the tubular barrel 406.

Referring now to FIG. 7, a pharmaceutical container 700 is illustrated including the syringe 402 and a sealing assembly 704. The sealing assembly 704 includes a stopper 718, a filler member 720, and a plunger 722. It should be appreciated that the above features of the stopper 106 and the filler member 107, such as the material of formation and CTE, are equally applicable to the stopper 718 and the filler member 720, respectively, discussed herein. As such, the stopper 718 has a first CTE and the filler member 720 has a second CTE lower than the first CTE.

As shown in FIG. 7, the stopper 718 has an inner wall 718a and an outer wall 718b opposite the inner wall 718a. The inner wall 718a defines a cavity 718c. The outer wall 718b defines one or more lobes 718d. The lobes 718d extend in a radial direction to contact the interior wall 414 of the tubular barrel 406. As shown, a pair of lobes 718d are illustrated defining one or more recesses 718e between adjacent lobes 718d. However, it should be appreciated that more than a pair of lobes 718d may be provided such as, for example, three, four, or five lobes. The stopper 718 has a constant thickness defined between the inner wall 718a and the outer wall 718b thereof. In embodiments, the interior a lubricant may be provided within the interior wall 414 of the tubular barrel 406 may be coated within a lubricant, and/or provided within the recess 718e, to facilitate sliding of the sealing assembly 704 within the interior 412 of the tubular barrel 406.

The filler member 720 is provided within the cavity 718c defined by the inner wall 718a of the stopper 718. The filler member 720 conforms to the shape of the cavity 718c to contact and extend along the inner wall 718a of the stopper 718. As such, the filler member 720 similar defines one or more lobes 720a. In embodiments in which the stopper 718 has a plurality of lobes 718d defining one or more recesses 718e, the filler member 720 similarly has a plurality of lobes 720a defining one or more recesses 720b, as shown in FIG. 7. The plunger 722 has a first end 722a which may be fixed, such as by being adhered, sonic welded, or the like, to one or both of the stopper 718 and the filler member 720. As shown, the first end 722a is fixed to the filler member 720.

From the above, it is to be appreciated that defined herein is a sealed pharmaceutical container including a container and a sealing assembly having a CTE lower than CTE of the container such that, when the sealed pharmaceutical container is subjected to relatively low temperatures, shrinkage of the sealing assembly relative to the container does not result in a gap in a seal formed between the container and the sealing assembly. Specifically, the sealing assembly includes a stopper including a filler member at least partially encased within the stopper. The filler member has a CTE lower than the CTE of the stopper and approximately the same or lower than the CTE of the container.

Further aspects of the embodiments described herein are provided by the subject matter of the following clauses:

Clause 1. A sealed pharmaceutical container comprising: a shoulder; a neck extending from the shoulder; a flange extending from the neck, the flange comprising: an underside surface extending from the neck; an outer surface extending from the underside surface, the outer surface defining an outer diameter of the flange; and an upper sealing surface extending between the outer surface and an inner surface defining an opening in the sealed pharmaceutical container, and a sealing assembly comprising: a stopper including a sealing portion extending over the upper sealing surface of the flange and covering the opening, and an insertion portion extending into the opening and in contact with the inner surface of the flange, the stopper having a first CTE; and a filler member encased within the stopper and having a second CTE, the second CTE being lower than the first CTE.

Clause 2. The sealed pharmaceutical container of clause 1, wherein the filler member comprises a first material, the first material including at least one of glass, a crystalline material, a polymer, and a metal.

Clause 3. The sealed pharmaceutical container of clause 2, wherein the first material includes at least one of oxide, halide, nitride, and chalcogen.

Clause 4. The sealed pharmaceutical container of clause 2, wherein the first material is coated with a second material, the second material including at least one of butyl rubber, nitrile rubber, fluoro rubber, butyl silicone rubber, and polyacrylate elastomer.

Clause 5. The sealed pharmaceutical container of clause 4, wherein the second material has a glass transition temperature (T_{g}) between −200° C. to 300° C.

Clause 6. The sealed pharmaceutical container of any of clauses 1-5, wherein the filler member includes a filler body having a body diameter greater than an opening diameter of the opening of the sealed pharmaceutical container.

Clause 7. The sealed pharmaceutical container of clause 6, wherein a body channel is formed extending through an upper surface of the filler body and a lower surface of the filler body.

Clause 8. The sealed pharmaceutical container of clause 7, wherein the filler member includes a filler protrusion extending at least partially through the opening of the pharmaceutical container and parallel to the inner surface of the pharmaceutical container.

Clause 9. The sealed pharmaceutical container of clause 8, wherein a protrusion channel is formed extending through an upper surface of the filler protrusion and a lower surface of the protrusion, the body and the protrusion form a one-piece monolithic structure, and the protrusion channel and the body channel are coaxial with one another.

Clause 10. The sealed pharmaceutical container of any of clauses 1-9, wherein the filler member includes a filler protrusion extending at least partially through the opening of the pharmaceutical container and parallel to the inner surface of the pharmaceutical container, the filler protrusion having a protrusion diameter less than an opening diameter of the opening of the sealed pharmaceutical container.

Clause 11. The sealed pharmaceutical container of any of clauses 1-10, wherein the sealing assembly maintains a helium leakage rate of the sealed pharmaceutical container at less than or equal to 1.4×10⁻⁶ cm³/s as the sealed pharmaceutical container is cooled to a temperature of less than or equal to −45° C.

Clause 12. The sealed pharmaceutical container of any of clauses 1-11, wherein the upper sealing surface is an inclined sealing surface extending at an angle relative to a plane extending through an end of the opening such that a distance between the inclined sealing surface and the plane increases with decreasing radial distance from the outer surface.

Clause 13. The sealed pharmaceutical container of any of clauses 1-12, wherein the flange is constructed of a composition having a coefficient of thermal expansion that is greater than or equal to 0×10-7/K and less than or equal to 70×10-7/K.

Clause 14. A sealed pharmaceutical container comprising: a syringe comprising: a tubular barrel having an open end and closed end opposite the open end; a needle extending from the closed end and in fluid communication with an interior of the tubular barrel defined by an inner wall of the tubular barrel; and a sealing assembly movably positioned within the interior of the tubular barrel, the sealing assembly comprising: a stopper having an inner wall and an outer wall opposite the inner wall at least partially in contact with the inner wall of the tubular barrel the stopper having a first CTE; a filler member at least partially encased within the stopper and having a second CTE, the second CTE being lower than the first CTE; and a plunger coupled to the stopper and extending through the open end of the tubular barrel.

Clause 15. The sealed pharmaceutical container of clause 14, wherein the filler member comprises a first material, the first material including at least one of glass, a crystalline material, a polymer, and a metal.

Clause 16. The sealed pharmaceutical container of clause 15, wherein the first material includes at least one of oxide, halide, nitride, and chalcogen.

Clause 17. The sealed pharmaceutical container of clause 15, wherein the stopper comprises a second material, the second material including at least one of butyl rubber, nitrile rubber, fluoro rubber, butyl silicone rubber, and polyacrylate elastomer.

Clause 18. The sealed pharmaceutical container of clause 17, wherein the second material has a T_{g} between −200° C. to 300° C.

Clause 19. The sealed pharmaceutical container of any of clauses 14-18, wherein the plunger includes a first end provided within the interior of the tubular barrel and a second end opposite the first end that is provided outside of the interior of the tubular barrel, the first end of the plunger fixed to the filler member.

Clause 20. The sealed pharmaceutical container of clause 19, wherein the filler member has a cavity formed therein.

Clause 21. The sealed pharmaceutical container of clause 20, wherein the plunger includes a flange formed at the first end thereof extending across the cavity formed in the filler member.

Clause 22. The sealed pharmaceutical container of clause 20, wherein the first end of the plunger is received within the cavity formed in the filler member.

Clause 23. The sealed pharmaceutical container of any of clauses 19-22, wherein the stopper and the filler member each includes a pair of lobes defining one or more recesses, the pair of lobes are in contact with an interior wall of the tubular barrel and the one or more recesses are spaced apart from the interior wall of the tubular barrel.

Clause 24. The sealed pharmaceutical container of any of clauses 14-23, wherein the tubular barrel is constructed of a composition having a coefficient of thermal expansion that is greater than or equal to 0×10-7/K and less than or equal to 70×10-7/K.

Clause 25. The sealed pharmaceutical container of claim any of clauses 14-24, wherein the sealed pharmaceutical container maintains a helium leakage rate at less than or equal to 1.4×10⁻⁶ cm³/s as it is cooled to the temperature at a rate of less than or equal to 5° C. per minute.

Clause 26. The sealed pharmaceutical container of any of clauses 14-24, wherein the sealing assembly maintains a helium leakage rate of the sealed pharmaceutical container at less than or equal to 1.4×10⁻⁶ cm³/s as the sealed pharmaceutical container is cooled to a temperature of less than or equal to −20° C.

Clause 27. The sealed pharmaceutical container of any of clauses 14-24, wherein the sealing assembly maintains a helium leakage rate of the sealed pharmaceutical container at less than or equal to 1.4×10⁻⁶ cm³/s as the sealed pharmaceutical container is cooled to a temperature of less than or equal to −120° C.

Clause 28. The sealed pharmaceutical container of any of clauses 14-24, wherein the sealing assembly maintains a helium leakage rate of the sealed pharmaceutical container at less than or equal to 1.4×10⁻⁶ cm³/s as the sealed pharmaceutical container is cooled to a temperature of less than or equal to −180° C.

Clause 29. A method of sealing a pharmaceutical container, the method comprising: providing a pharmaceutical container comprising a shoulder, a neck extending from the shoulder and a flange extending from the neck, the flange comprising: an underside surface extending from the neck; an outer surface extending from the underside surface, the outer surface defining an outer diameter of the flange; and an upper sealing surface extending between the outer surface to an inner surface of the pharmaceutical container that defines an opening; inserting a pharmaceutical composition into the pharmaceutical container; and providing a stopper including a sealing portion extending over the upper sealing surface of the flange and covering the opening, and an insertion portion extending into the opening and in contact with the inner surface of the flange, the stopper having a first CTE, a filler member encased within the stopper and having a second CTE, the second CTE being lower than the first CTE.

Clause 30. The method of clause 29, further comprising cooling the pharmaceutical container to a temperature of less than or equal to −20° C., wherein, after the cooling of the pharmaceutical container, the compression is maintained on the upper sealing surface such that a helium leakage rate of the pharmaceutical container is less than or equal to 1.4×10⁻⁶ cm³/s at the temperature.

Clause 31. The method of clause 29 or clause 30, wherein the filler member comprises a first material, the first material including at least one of glass, a crystalline material, a polymer, and a metal.

Clause 32. The method of clause 31, wherein the first material is coated with a second material, the second material including at least one of butyl rubber, nitrile rubber, fluoro rubber, butyl silicone rubber, and polyacrylate elastomer.

Clause 33. The method of clause 32, wherein the second material has a T_{g} between −200° C. to 300° C.

Clause 34. The method of any of clauses 29-33, wherein the filler member includes a filler body having a body diameter equal to or greater than an opening diameter of the opening of the pharmaceutical container.

Clause 35. The method of claim 34, wherein a body channel is formed extending through an upper surface of the body and a lower surface of the body.

Clause 36. The method of clause 35, wherein the filler member includes a filler protrusion extending at least partially through the opening of the pharmaceutical container and parallel to the inner surface of the pharmaceutical container.

Clause 37. The method of clause 36, wherein a protrusion channel is formed extending through an upper surface of the protrusion and a lower surface of the filler protrusion, the filler body and the filler protrusion form a one-piece monolithic structure, and the protrusion channel and the body channel are coaxial with one another.

Clause 38. The method of any of clause 29, wherein the filler member includes a filler protrusion extending at least partially through the opening of the pharmaceutical container and parallel to the inner surface of the pharmaceutical container, the filler protrusion having a protrusion diameter less than an opening diameter of the opening of the pharmaceutical container.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A sealed pharmaceutical container comprising:
a shoulder;
a neck extending from the shoulder;
a flange extending from the neck, the flange comprising:
an underside surface extending from the neck;
an outer surface extending from the underside surface, the outer surface defining an outer diameter of the flange; and
an upper sealing surface extending between the outer surface and an inner surface defining an opening in the sealed pharmaceutical container, and
a sealing assembly comprising:
a stopper including a sealing portion extending over the upper sealing surface of the flange and covering the opening, and an insertion portion extending into the opening and in contact with the inner surface of the flange, the stopper having a first CTE; and
a filler member encased within the stopper and having a second CTE, the second CTE being lower than the first CTE.

2. The sealed pharmaceutical container of claim 1, wherein the filler member comprises a first material, the first material including at least one of glass, a crystalline material, a polymer, and a metal.

3. The sealed pharmaceutical container of claim 2, wherein the first material includes at least one of oxide, halide, nitride, and chalcogen.

4. The sealed pharmaceutical container of claim 2, wherein the first material is coated with a second material, the second material including at least one of butyl rubber, nitrile rubber, fluoro rubber, butyl silicone rubber, and polyacrylate elastomer.

5. The sealed pharmaceutical container of claim 4, wherein the second material has a T_{g} between −200° C. to 300° C.

6. The sealed pharmaceutical container of claim 1, wherein the filler member includes a filler body having a body diameter greater than an opening diameter of the opening of the sealed pharmaceutical container.

7. The sealed pharmaceutical container of claim 6, wherein a body channel is formed extending through an upper surface of the filler body and a lower surface of the filler body.

8. The sealed pharmaceutical container of claim 7, wherein the filler member includes a filler protrusion extending at least partially through the opening of the pharmaceutical container and parallel to the inner surface of the pharmaceutical container.

9. The sealed pharmaceutical container of claim 8, wherein a protrusion channel is formed extending through an upper surface of the filler protrusion and a lower surface of the protrusion, the body and the protrusion form a one-piece monolithic structure, and the protrusion channel and the body channel are coaxial with one another.

10. The sealed pharmaceutical container of claim 1, wherein the filler member includes a filler protrusion extending at least partially through the opening of the pharmaceutical container and parallel to the inner surface of the pharmaceutical container, the filler protrusion having a protrusion diameter less than an opening diameter of the opening of the sealed pharmaceutical container.

11. The sealed pharmaceutical container of claim 1, wherein the sealing assembly maintains a helium leakage rate of the sealed pharmaceutical container at less than or equal to 1.4×10⁻⁶ cm³/s as the sealed pharmaceutical container is cooled to a temperature of less than or equal to −45° C.

12. The sealed pharmaceutical container of claim 1, wherein the upper sealing surface is an inclined sealing surface extending at an angle relative to a plane extending through an end of the opening such that a distance between the inclined sealing surface and the plane increases with decreasing radial distance from the outer surface.

13. The sealed pharmaceutical container of claim 1, wherein the flange is constructed of a composition having a coefficient of thermal expansion that is greater than or equal to 0×10⁻⁷/K and less than or equal to 70×10′″/K.

14. A method of sealing a pharmaceutical container, the method comprising:
providing a pharmaceutical container comprising a shoulder, a neck extending from the shoulder and a flange extending from the neck, the flange comprising:
an underside surface extending from the neck;
an outer surface extending from the underside surface, the outer surface defining an outer diameter of the flange; and
an upper sealing surface extending between the outer surface to an inner surface of the pharmaceutical container that defines an opening;
inserting a pharmaceutical composition into the pharmaceutical container; and
providing a stopper including a sealing portion extending over the upper sealing surface of the flange and covering the opening, and an insertion portion extending into the opening and in contact with the inner surface of the flange, the stopper having a first CTE, a filler member encased within the stopper and having a second CTE, the second CTE being lower than the first CTE.

15. The method of claim 14, further comprising cooling the pharmaceutical container to a temperature of less than or equal to −20° C., wherein, after the cooling of the pharmaceutical container, the compression is maintained on the upper sealing surface such that a helium leakage rate of the pharmaceutical container is less than or equal to 1.4×10⁻⁶ cm³/s at the temperature.

16. The method of claim 14, wherein the filler member comprises a first material, the first material including at least one of glass, a crystalline material, a polymer, and a metal.

17. The method of claim 16, wherein the first material is coated with a second material, the second material including at least one of butyl rubber, nitrile rubber, fluoro rubber, butyl silicone rubber, and polyacrylate elastomer.

18. The method of claim 17, wherein the second material has a T_{g} between −200° C. to 300° C.

19. The method of claim 14, wherein the filler member includes a filler body having a body diameter equal to or greater than an opening diameter of the opening of the pharmaceutical container.

20. The method of claim 19, wherein a body channel is formed extending through an upper surface of the body and a lower surface of the body.

21. The method of claim 20, wherein the filler member includes a filler protrusion extending at least partially through the opening of the pharmaceutical container and parallel to the inner surface of the pharmaceutical container.

22. The method of claim 21, wherein a protrusion channel is formed extending through an upper surface of the protrusion and a lower surface of the filler protrusion, the filler body and the filler protrusion form a one-piece monolithic structure, and the protrusion channel and the body channel are coaxial with one another.

23. The method of claim 14, wherein the filler member includes a filler protrusion extending at least partially through the opening of the pharmaceutical container and parallel to the inner surface of the pharmaceutical container, the filler protrusion having a protrusion diameter less than an opening diameter of the opening of the pharmaceutical container.
